(19) United States
(12) Patent Application Publication
(10) Pub. No.: US 2014/0207503 A1
(43) Pub. Date: Jul. 24, 2014

(54) SKILL MAPPING ANALYSIS

(71) Applicant: INTERNATIONAL BUSINESS MACHINES CORPORATION, Armonk, NY (US)

(72) Inventor: Roberta L. Reis, Sao Paulo (BR)

(73) Assignee: INTERNATIONAL BUSINESS MACHINES CORPORATION, Armonk, NY (US)

(21) Appl. No.: 13/745,148

(22) Filed: Jan. 18, 2013

(51) Int. Cl. G06Q 10/06

(52) U.S. Cl. CPC G06Q 10/06311
USPC 705/7.13

(57) ABSTRACT

A method, system and computer program product are disclosed for allocating people to subdivisions of a team. A set of skills is assigned to the team, and each of the skills has a range of skill levels. In one embodiment, the method comprises establishing, for each of the team subdivisions, a plurality of the skill levels for the set of skills, and determining a profile for the subdivision based on the skill levels established for the subdivision. For each person of a group of people, one skill level is assigned to the person for each skill of the set of skills, a profile is calculated for the person based on the skill levels assigned to the person, and the person is allocated to one of the subdivisions based on a comparison of the profile of the person and the profile of one or more of the subdivisions.

### BACKGROUND

This invention generally relates to skill mapping analysis, and more specifically, to assigning employees to groups based on an analysis of the mapping of skills of the employees.

Increasingly, an organization's ability to achieve targeted goals and objectives depends not only on whether the organization has a well trained workforce, but also on whether the organization is able to define the proper skills and skill levels needed to achieve those goals and objects and to identify the appropriate personnel for each assignment.

Traditionally, organizations have focused their workforce by creating fairly narrowly defined jobs and improving the skill-sets of the individuals in those jobs by using periodic training. However, as the workplace environment becomes ever more dynamic, job requirements are becoming increasingly more fluid with corresponding employee skill deficiencies that need to be identified in near real-time. Modern day organizations require their workforce to have varying levels of knowledge and skills in the same subjects. Organizations are posturing themselves to develop accurate profiles of their employees, knowing what knowledge and skills 45 are present within the organization, the competency levels required for each job, where the deficiencies are, and how to provide timely skills upgrading.

In order to manage employees most efficiently, skills management and assignment systems and methods need to incorporate automated techniques that can perform the analysis of employee skill levels and provide a regimen for assembling team groups that will bring the appropriate personnel together for each assignments or work task.

### BRIEF SUMMARY

Embodiments of the invention provide a method, system and computer program product for allocating people to a number of subdivisions of a team. A set of skills is assigned to the team, and each of the skills has a range of skill levels. In one embodiment, the method comprises establishing, for each of the subdivisions of the team, a plurality of the skill levels for the set of skills, and determining a profile for said each subdivision based on the skill levels established for the subdivision. The embodiment further comprises, for each person of a group of people, assigning one of the skill levels to said each person for each skill of the set of skills, calculating a profile for said each person based on the skill levels assigned to said each person, and allocating said each person to one of the subdivisions of the team based on a comparison of the profile of said each person and the profile of one or more of the subdivisions of the team.

In one embodiment, the profile for each subdivision and the profile for each person is a numeric profile score, and each person is allocated to one of the subdivisions based on a comparison of the numeric profile score for said each person and the numeric profile score for the one or more of the subdivisions.

In an embodiment, a number is assigned to each of the skill levels.

In one embodiment, a band of the skill levels is established for each of the skills for each of the team subdivisions.

In an embodiment, the band for each skill is established by minimum and maximum skill levels for the skill.

In one embodiment, the profile for each team subdivision is determined based on the minimum skill levels established for said each subdivision.

In one embodiment, the profile for each of the subdivisions is a profile score equal to a sum of numbers based on the numbers assigned to the minimum skill levels established for said each subdivision.

In an embodiment, the profile for each person is a profile score equal to a sum of numbers based on the numbers assigned to the skill levels assigned to said each person.

In one embodiment, each person is allocated to one of the subdivisions based on a comparison of the profile score for said each person and the profile score for one or more of the team subdivisions.

In an embodiment, a comparison of the profile of at least one person of the group of people and the profile of one of the subdivisions is visually depicted to illustrate visually one or more gaps between the skill levels of said one person and the skill levels established for said one of the subdivisions.

In the implementation of embodiments of the invention, a team for a support area is formed for analysts with different levels of knowledge and experience. Embodiments of the invention identify skill profiles for each of a group of different levels of skills, and analyze the professional profiles of a group of employees to place the employees in the appropriate team subdivision. Problems and issues to be handled by the team of analysts are classified based on their complexity and then distributed to the team subdivisions accordingly.

Subdividing the team of analysts and distributing the problems and issues to the team subdivisions in this way avoids situations where highly skilled employees work on simple issues, which is not an efficient use of these employees, and avoids situations where lower skilled analysts work on very demanding issues, which may compromise the quality of the services delivered by these analysts.

Once employees are placed in a team group or subdivision, embodiments of the invention may provide to those employees graphical profiles analyses that identify gaps between the employees' skills and the skill levels of the team subdivision.

Based on these analyses, the employees and their manager may create individual plans to improve the employees' skills and knowledge and to eliminate or fill the gaps between the employees' skills and knowledge and the skill and knowledge levels of the team subdivision. These plans help make the employees prepared to achieve better quality work product and better overall results.

Also, the employees, using embodiments of the invention, may be better able to pursue their career development by identifying gaps in their skills and knowledge that need to be eliminated or improved By eliminating or improving these skill gaps, the employees enable themselves to be placed on a team group or subdivision requiring higher skills.

In embodiments of the invention, the input for the skill mapping is a list of the skill level definitions of all employees. A process to obtain such a list is described in the publication “Decision Support Tool Based On Skill Mapping,” published by ip.com, IP.com number IPCOM000198611D, IP.com Electronic Publication, Aug. 10, 2010 (2010), the disclosure of which is hereby incorporated herein by reference in its entirety. This publication describes a skill levels definition process for job roles.

Embodiments of the invention use this input and create the flowing outputs:

A. A graphical mapping of the team subdivisions using a fuzzy logic;

B. A visualization of individual skills and knowledge gaps; and

C. A rank of the analysts.

Embodiments of the invention provide a graphical output that takes into account the analysis of a group of different skills. Embodiments of the invention provide an output related to how appropriate an employee skill profile is to perform on his or her assigned team subdivision or group. Embodiments of the invention provide a graphical resource to visualize team subdivisions or groups and a comparison of employee skill profiles with the skills levels set for those team subdivisions.

### BRIEF DESCRIPTION OF THE SEVERAL VIEWS OF THE DRAWINGS

FIG. 1 illustrates a skill mapping analysis according to an embodiment of the invention.

FIG. 2 is a table showing an example of team subdivision definitions.

FIG. 3 is a graphic illustrating a profile of one team subdivision.

FIG. 4 is a graphic showing a profile of a second team subdivision.

FIG. 5 is a graphic depicting a profile of a third team subdivision.

FIG. 6 is a graphic showing a profile of an analyst superimposed on the profile of the second team subdivision.

FIG. 7 shows the skill levels of a particular analyst

FIG. 8 shows a comparison of the skill profile of the analyst having the skill levels listed in FIG. 7 and the profile of a team subdivision.

FIG. 9 is a table that gives the requirements for each of the skill levels for a set of skills.

FIG. 10 is a table that gives the minimum and maximum skill levels established for each of three team subdivisions.

FIG. 11 is a graphical output of an embodiment of the invention illustrating the skill mapping analysis of an analyst on one of the three team subdivisions.

FIG. 12 is a graphical output of an embodiment of the invention depicting the skill mapping analysis of the analyst on a second of the three team subdivisions.

FIG. 13 is a graphical output of an embodiment of the invention showing the skill mapping analysis of the analyst on a third of the team subdivisions.

FIG. 14 illustrates a computing environment in which the present invention may be implemented.

### DETAILED DESCRIPTION

As will be appreciated by one skilled in the art, embodiments of the present invention may be embodied as a system, method or computer program product. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

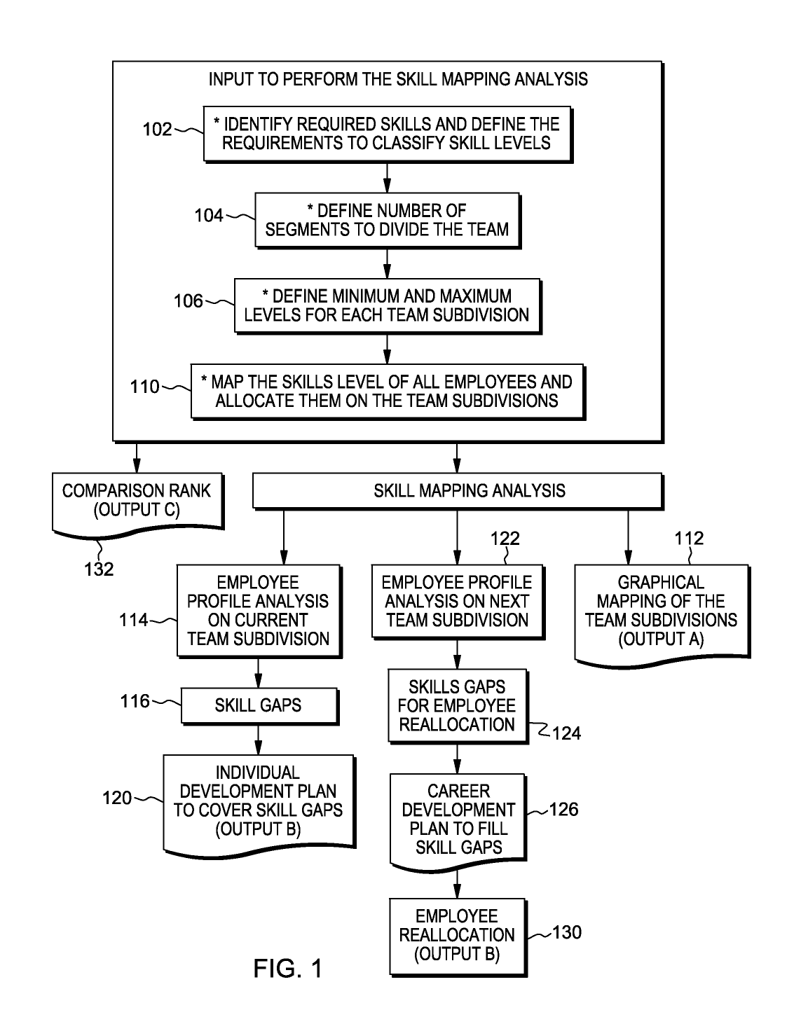

The present invention relates to skill mapping analysis, including assigning, or allocating, employees to groups based on mappings of the skills of the employees. FIG. 1 illustrates a flow chart showing implementation phases of a decision support tool based on a skill mapping process in accordance with an embodiment of the invention. In embodiments of the invention, the input for the skill mapping is a list of the skill level definitions of all employees. The outputs include:

A. A graphical mapping of the team subdivisions using a fuzzy logic;

B. A visualization of individual skills and knowledge gaps; and

C. A rank of the analysts.

With reference to FIG. 1, step 102 is to identify, or map, the skills required to work as a system analyst on the team, and to define the requirements for each skill level. Some examples of skills are: Educational Degree, Professional Certification and Experience with a particular technology. In embodiments of the invention, the requirements are measurable parameters such as, for example, the number of technical certifications an employee has, and the length of time an employee has experience working with a particular technology.

Step 104 is to define the number of subdivisions into which the team is divided, and step 106 is to set minimum and maximum levels for each skill for each team subdivision. This determines the number of levels into which the team is divided. Once the profiles for the team subdivisions are created, the next step 110 is to interview the employees and to map, or determine, their professional profiles.

Embodiments of the invention utilize a tool, referred to as Skill Mapping, that is a decision support tool used to show subdivisions or groups within a team based on skill levels, and to represent these subdivisions graphically. The tool may also be used to show graphically the skill profiles of employees in combination with the graphic representations of the team subdivisions.

The subdivisions are defined by setting, for each subdivision, minimum and maximum levels for each of a set of skills, thus giving a range of desirable skill levels within each team subdivision. The employee skill profiles are defined using the same parameters that are used to define the skill levels for the team subdivisions. A fuzzy logic, based on a comparison of the employee skill levels and the skill levels set for each team subdivision, is used to determine which team subdivision to which each employee will be allocated.

The graphical output provided by the decision support tool is a valuable resource to visualize the minimum and maximum requirements per team subdivision, as represented at 112, and the comparison of the skill profiles of the employees to these requirements, as represented at 114. This comparison shows the gaps, represented at 116, between an employee's skills and the skill levels established for the team subdivision, or level, where the employee is placed.

For example, a support team that would require a particular skill set to work on specified issues may be divided using this methodology into three subdivisions or groups, providing support levels 1, 2 and 3, with level 3 being the highest skill level. Each group will have employees assigned to it, to work on problems and issues, according to the skill level of the group.

By comparing an employee's skill profile with the required skill profiles of the different groups, the tool will identify the skill gaps that the employee needs to fill in order for the employee to perform his or her work efficiently and with the highest quality. Also, the employee will have valuable career insight through the visualization of his or her individual skill gaps to identify specific areas that need improvement. This insight will help the employee design an individual development plan, as represented at 120, in order to improve their professional skills sufficiently to be transferred to a team group having higher skill levels.

A tool that may be used in embodiments of the invention is described in the above-identified publication “Decision Support Tool Based On Skill Mapping,” the disclosure of which is hereby incorporated herein by reference in its entirety.

Once the tool is implemented, it may be used to analyze the graphical profile of each employee individually and to identify the skill gaps or deficiencies of the employees, enabling the employees to improve their skills and to deliver higher quality services.

In addition, as represented at 122, 124, 126 and 130, embodiments of the invention provide the parameters to prepare the employees to be re-allocated or re-assigned to a different team subdivision. This is done by providing a visualization of the gaps in an employee's skill or knowledge levels that need to be improved upon in order to make the employee's profile appropriate for the skill level of a different team subdivision.

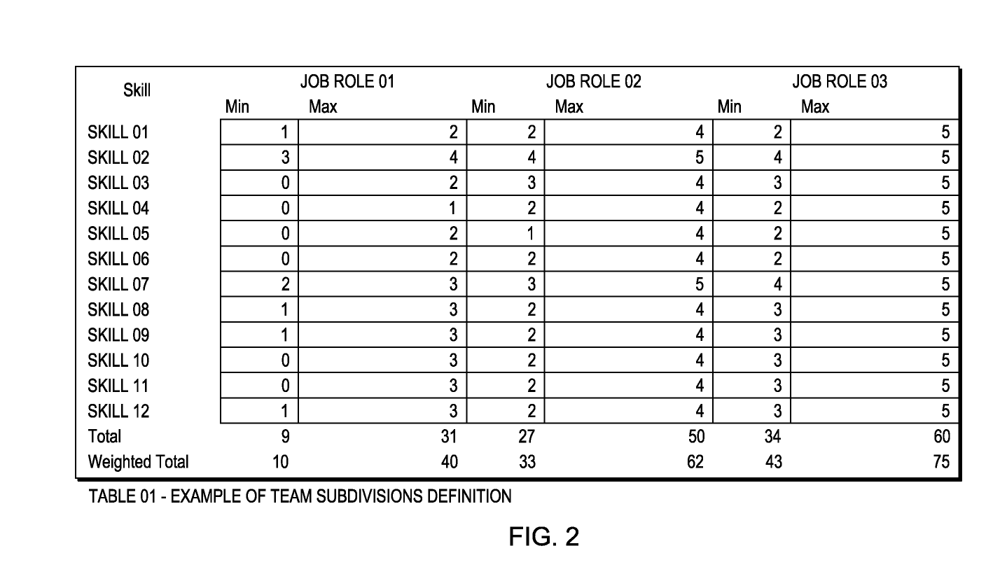

FIG. 2 shows a table that gives an example of how to set minimum and maximum skill levels for each team subdivision. As shown in this table, one team subdivision, which is assigned job role 01, has a skill level between 1 and 2 for skill 01, a skill level between 3 and 4 for skill 02, and a skill level between 0 and 2 for skill 03. Another team subdivision, which is assigned job role 02, has a skill level between 2 and 4 for each of the skills 08-12.

In some cases, the skill level bands of different team subdivisions may overlap. With the example shown in FIG. 2, the team subdivision assigned to job role 02 requires a skill level between 2 and 4 for skill 01, and the team subdivision assigned to job role 03 has a skill level between 2 and 5 for the same skill.

For some teams or in some circumstances, certain skills may be more important than others. When using embodiments of the invention, a team may set some weight for the most important skills in order to create a team profile close to a profile that would be optimal or preferred for the job role or roles assigned to that team subdivision.

For example, the skills 10, 11 and 12 listed in FIG. 2 may be double weighted. Therefore, for the team subdivision assigned to job role 01, a weighted total skill level value may be calculated as:

1+3+0+0+0+0+2+1+1+2(0+0+1)=10

Providing a total, weighted value in this way for a team subdivision is part of the fuzzy logic used to allocate the employees. If an employee's profile rate, or score, is greater than the weighted total of the profile score of a team subdivision, the employee will be considered appropriate to perform on that team.

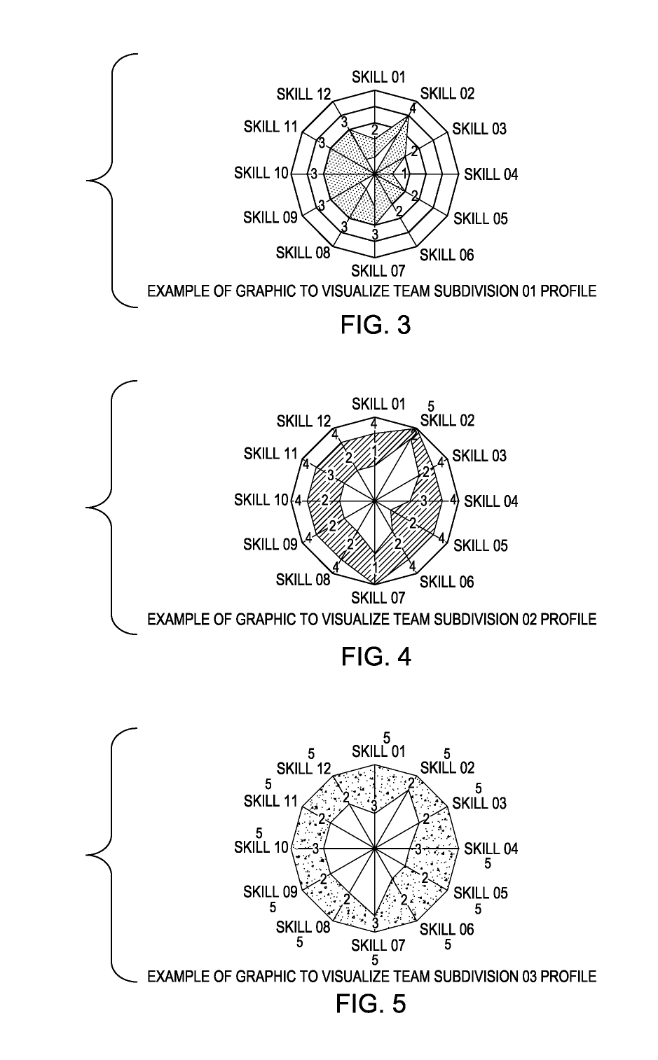

FIGS. 3, 4 and 5 show diagrams, referred to as radar graphics, that illustrate the three sets of the minimum and maximum skill levels listed in the table of FIG. 2. Each set of the skill levels form the profile for a respective one team subdivision.

Once the profiles for the team subdivisions are created, the employees are interviewed to map, or determine, their professional profiles. This mapping may be done, as an example, by calculating a profile score or a weighted profile score for each employee. This may be done in a manner similar to the way in which profile scores were calculated for the team subdivisions—that is, by adding the values, or weighted values, given to the employee's skills.

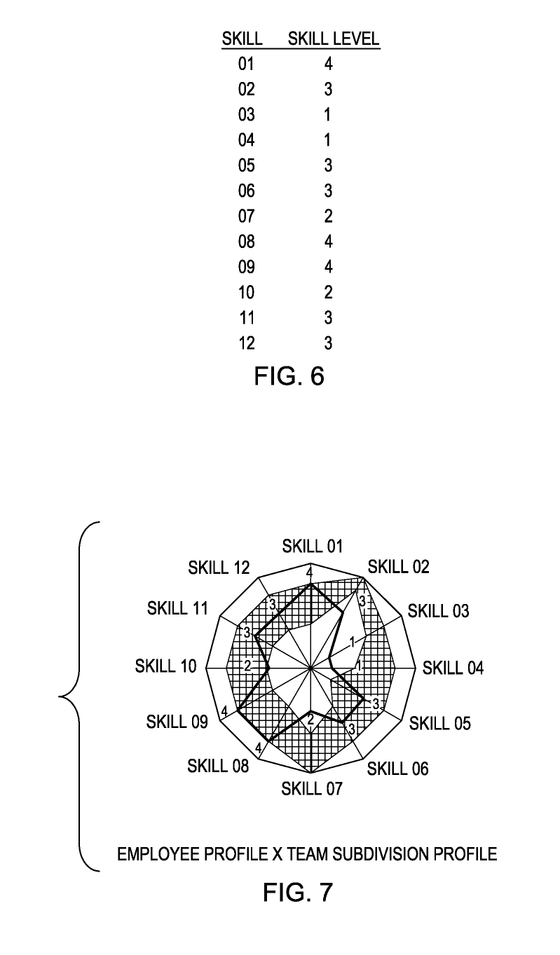

For instance, an employee may have the skill values shown in FIG. 6. The profile score for the employee may be obtained, as one example, by adding these skill values:

4+3+1+1+3+3+2+4+4+2+3+3=33

In embodiments of the invention, weights may be given to various skills. For example, a weight of 2 may be given to skills 10-12. In this case, the profile score for the employee would be:

4+3+1+1+3+3+2+4+4+2(2+3+3)=41

When the employees' profile rates have been determined, the employees can be allocated to the team subdivisions. In one embodiment, as part of the above-mentioned fuzzy logic used to allocate the employees, if an employee's profile rate is higher than the weighted total minimum profile score of a team subdivision, the employee will be considered appropriate to perform on that team subdivision.

FIG. 7 shows, as an example, a comparison of the skill profile of the analyst having the skill levels listed in FIG. 6 and the skill band of a team subdivision. As can be seen, although the overall profile of the employee is appropriate to perform on this team subdivision, the employee has some skill gaps—that is, for some of the skills, the skill level of the employee is less than the minimum level established for this team for these skills.

Besides using the tool of embodiments of the invention to provide the comparison, shown in FIG. 7, to visualize the skill gaps on the team subdivision on which the employee is placed, the employee may also use the tool to pursue his or her professional development by recognizing or learning what skill gaps need to be covered or reduced in order to make his or her profile appropriate for another, higher skilled, more demanding team subdivision.

The above-mentioned fuzzy logic is used to calculate, for every employee, the most appropriate group or team subdivision to allocate the employee to.

Additionally, as represented at 132 in FIG. 1, a team management can use the employee profiles to rank the employees and to identify within the team:

1. The highest skilled analysts;

2. The analysts that need to enhance their skills; and

3. The analysts already prepared to move to a more demanding team subdivision.

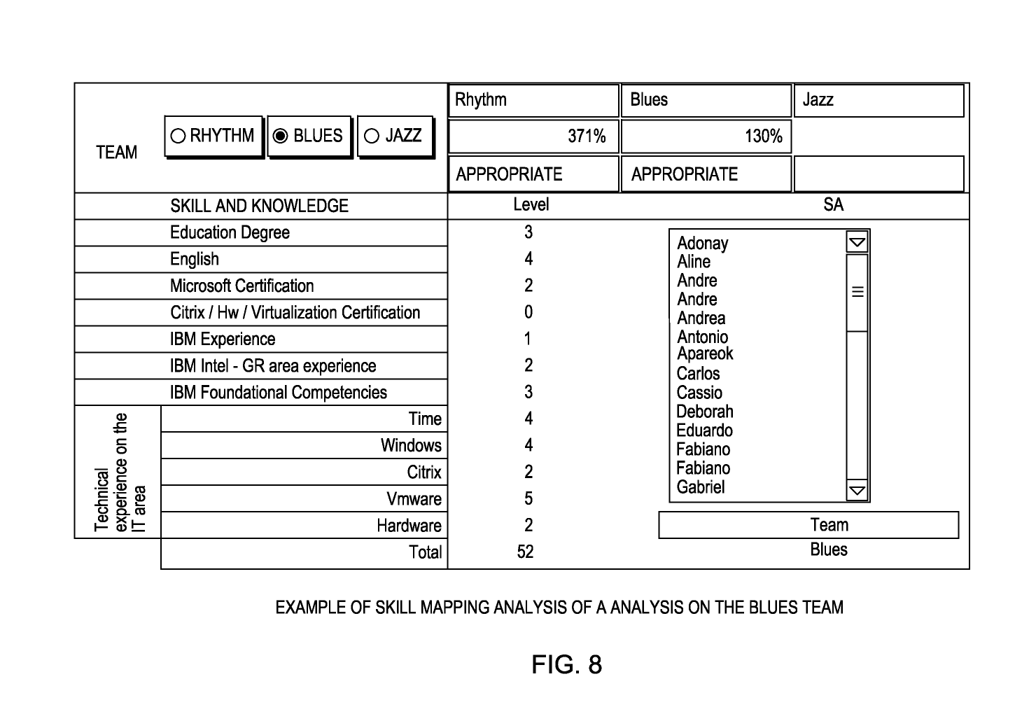

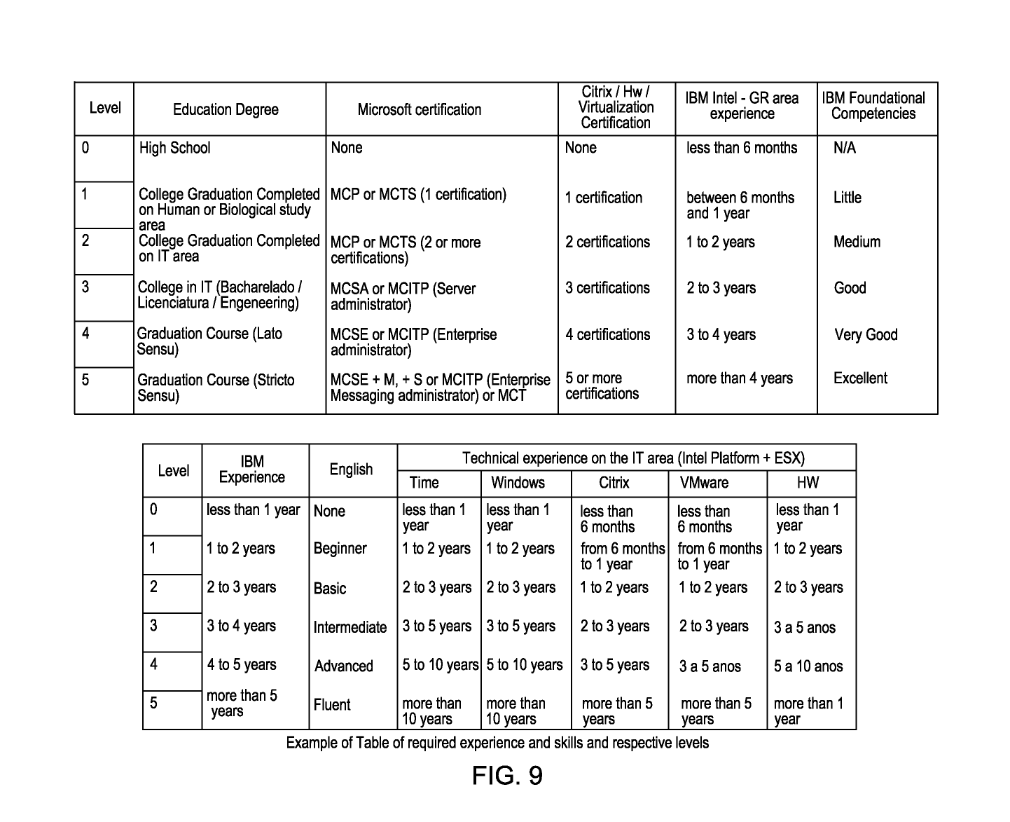

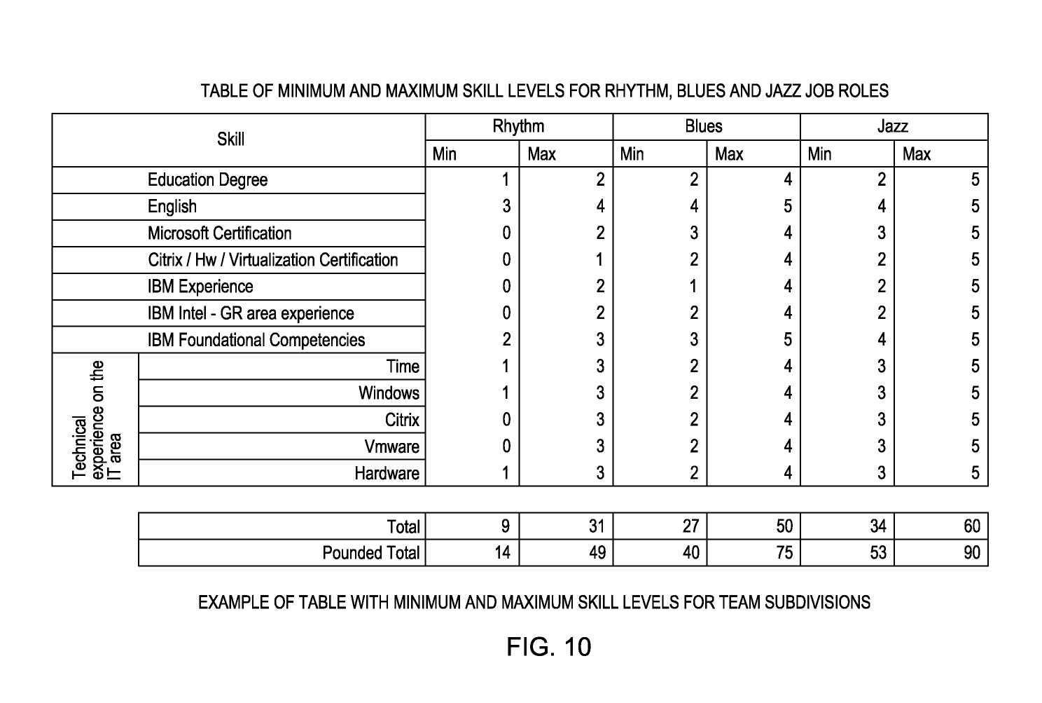

FIGS. 8-13 illustrate an example of how embodiments of the present invention can be implemented. In this implementation, a team of analysts was divided in team subdivisions, shown in FIG. 8, named Rhythm, blues and Jazz. FIG. 9 shows the requirements for the skill levels for the skills required for the team, and FIG. 10 shows the minimum and maximum levels established for each of the required skills for the different team subdivisions.

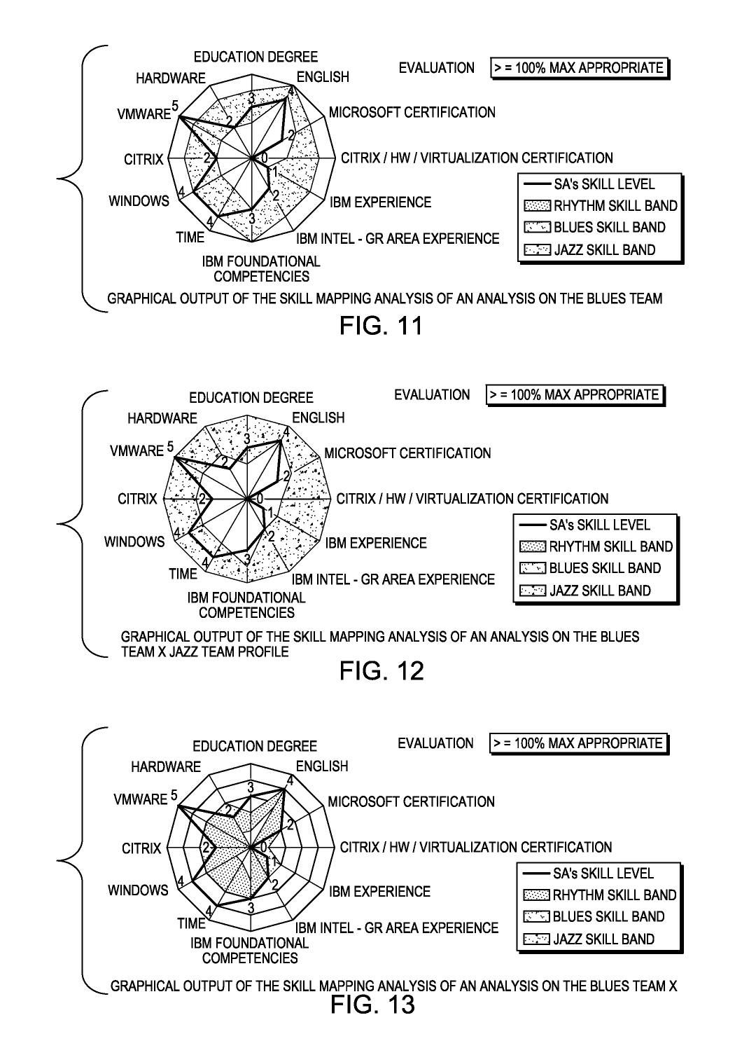

As an example, FIG. 8 lists the skill levels of one particular analyst, and indicated that this analyst—using the above-described fuzzy logic—is appropriate for both the Rhythm and Blues subdivisions. FIG. 11 is a graphical output of an embodiment of the invention illustrating a radar graphic showing the skill band set for the Blues team subdivision and the skills profile of this analyst on that subdivision.

FIGS. 12 and 13 are additional graphical outputs of embodiments of the invention. FIG. 12 illustrates how the skills profile of the above-mentioned analyst maps to the skill profile band set for the Jazz subdivision, and FIG. 13 shows how the skills profile of this analyst maps to the skills profile for the Rhythm subdivision.

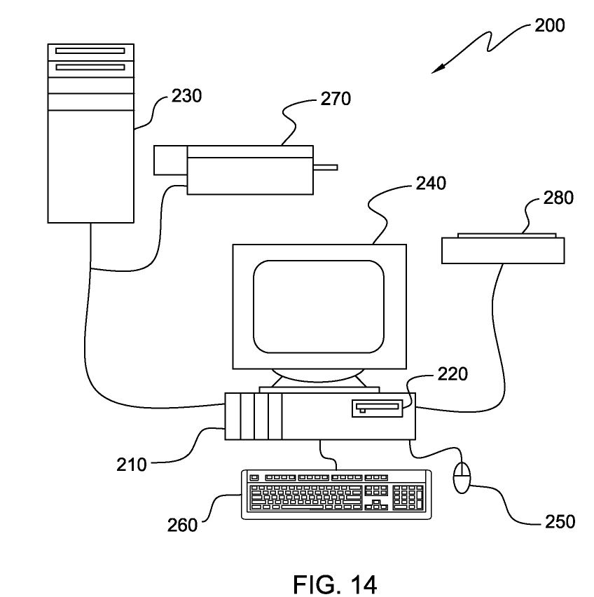

A computer-based system 200 in which a method embodiment of the invention may be carried out is depicted in FIG. 14. The computer-based system 200 includes a processing unit 210, which houses a processor, memory and other systems components (not shown expressly in the drawing) that implement a general purpose processing system, or computer that may execute a computer program product. The computer program product may comprise media, for example a compact storage medium such as a compact disc, which may be read by the processing unit 210 through a disc drive 220, or by any means known to the skilled artisan for providing the computer program product to the general purpose processing system for execution thereby.

The computer program product may comprise all the respective features enabling the implementation of the inventive method described herein, and which—when loaded in a computer system—is able to carry out the method. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer program product may be stored on hard disk drives within processing unit 210, as mentioned, or may be located on a remote system such as a server 230, coupled to processing unit 210, via a network interface such as an Ethernet interface. Monitor 240, mouse 250 and keyboard 260 are coupled to the processing unit 210, to provide user interaction. Scanner 280 and printer 270 are provided for document input and output. Printer 270 is shown coupled to the processing unit 210 via a network connection, but may be coupled directly to the processing unit. Scanner 280 is shown coupled to the processing unit 210 directly, but it should be understood that peripherals might be network coupled, or direct coupled without affecting the performance of the processing unit 210.

The description of the present invention has been presented for purposes of illustration and description, and is not intended to be exhaustive or to limit the invention in the form disclosed. Many modifications and variations will be apparent to those of ordinary skill in the art without departing from the scope of the invention. The embodiments disclosed herein were chosen and described in order to explain the principles and application of the invention, and to enable those of ordinary skill in the art to understand the invention for various embodiments with various modifications as are suited to the particular use contemplated.

What is claimed is:

1. A method of allocating people to a number of subdivisions of a team, wherein a set of skills is assigned to the team, and each of the skills has a range of skill levels, the method comprising:
establishing, for each of the subdivisions of the team, a plurality of the skill levels for the set of skills, and determining a profile for said each subdivision based on the skill levels established for the subdivision;
for each person of a group of people, assigning one of the skill levels to said each person for each skill of the set of skills, calculating a profile for said each person based on the skill levels assigned to said each person, and allocating said each person to one of the subdivisions of the team based on a comparison of the profile of said each person and the profile of one or more of the subdivisions of the team.

2. The method according to claim 1, wherein:
the determining a profile for each subdivision includes determining a numeric profile score for said each subdivision;
the calculating a profile for said each person includes calculating a numeric profile score for said each person; and
the allocating includes allocating said each person to one of the subdivisions based on a comparison of the numeric profile score for said each person and the numeric profile score for the one or more of the subdivisions.

3. The method according to claim 1, wherein a number is assigned to each of the skill levels.

4. The method according to claim 3, wherein the establishing, for each subdivision, a plurality of the skill levels for the skills includes establishing a band of the skill levels for each of the skills for said each subdivision.

5. The method according to claim 4, wherein the establishing a band of the skill levels for each of the skills includes establishing minimum and maximum skill levels for each of the skills for each of the subdivisions.

6. The method according to claim 5, wherein the determining a profile for said each subdivision includes determining the profile for each subdivision based on the minimum skill levels established for said each subdivision.

7. The method according to claim 6, wherein the profile for each of the subdivisions is a profile score equal to a sum of numbers based on the numbers assigned to the minimum skill levels established for said each subdivision.

8. The method according to claim 7, wherein the profile for said each person is a profile score equal to a sum of numbers based on the numbers assigned to the skill levels assigned to said each person.

9. The method according to claim 8, wherein the allocating includes allocating said each person to one of the subdivisions based on a comparison of the profile score for said each person and the profile score for one or more of the subdivisions.

10. The method according to claim 1, further comprising visually depicting a comparison of the profile of at least one person of the group of people, and the profile of one of the subdivisions to illustrate visually one or more gaps between the skill levels of said one person and the skill levels established for said one of the subdivisions.

11. A system for allocating people to a number of subdivisions of a team, wherein a set of skills is assigned to the team, each of the skills has a range of skill levels, a plurality of the skill levels are established for the skills for each of the subdivisions and one of the skill levels is assigned to each person of a group of people for each skill of the set of skills, the system comprising:
one or more processing units configured for:
determining a profile for each of the subdivisions of the team based on the skill levels established for said each subdivision; and
for each person of the group of people, calculating a profile for said each person based on the skill levels assigned to said each person, and allocating said each person to one of the subdivisions of the team based on a comparison of the profile of said each person and the profile of one or more of the subdivisions of the team.

12. The system according to claim 11, wherein:
the determining a profile for each subdivision includes determining a numeric profile score for said each subdivision;
the calculating a profile for said each person includes calculating a numeric profile score for said each person; and
the allocating includes allocating said each person to one of the subdivisions based on a comparison of the numeric profile score for said each person and the numeric profile score for the one or more of the subdivisions.

13. The system according to claim 12, wherein minimum and maximum skill levels are established for each of the skills for each of the subdivisions, and wherein:
the determining a profile for said each subdivision includes determining the profile for each subdivision based on the minimum skill levels established for said each subdivision.

14. The system according to claim 13, wherein:
the profile for each of the subdivisions is a profile score equal to a sum of numbers based on numbers assigned to the minimum skill levels established for said each subdivision; and
the profile for said each person is a profile score equal to a sum of numbers based on numbers assigned to the skill levels assigned to said each person.

15. The system according to claim 14, wherein the allocating includes allocating said each person to one of the subdivisions based on a comparison of the profile score for said each person and the profile score for one or more of the subdivisions.

16. An article of manufacture comprising:
at least one tangible, computer readable device having program code logic tangibly embodied therein to allocate a group of people to a number of subdivisions of a team, wherein a set of skills is assigned to the team, each of the skills has a range of skill levels, a plurality of the skill levels are established for the skills for each of the subdivisions, and each person of the group of people is assigned one of the skill levels for each skill of the set of skills, the computer readable program code logic, when executing on a computer:
determining a profile for each of the subdivisions of the team based on the skill levels established for said each subdivision; and
for each person of the group of people, calculating a profile for said each person based on the skill levels assigned to said each person, and allocating said each person to one of the subdivisions of the team based on a comparison of the profile of said each person and the profile of one or more of the subdivisions of the team.

17. The article of manufacture according to claim 16, wherein:
the determining a profile for each subdivision includes determining a numeric profile score for said each subdivision;
the calculating a profile for said each person includes calculating a numeric profile score for said each person; and
the allocating includes allocating said each person to one of the subdivisions based on a comparison of the numeric profile score for said each person and the numeric profile score for the one or more of the subdivisions.

18. The article of manufacture according to claim 17, wherein minimum and maximum skill levels are established for each of the skills for each of the subdivisions, and wherein:
the determining a profile for said each subdivision includes determining the profile for each subdivision based on the minimum skill levels established for said each subdivision.

19. The article of manufacture according to claim 18, wherein:
the profile for each of the subdivisions is a profile score equal to a sum of numbers based on numbers assigned to the minimum skill levels established for said each subdivision; and
the profile for said each person is a profile score equal to a sum of numbers based on numbers assigned to the skill levels assigned to said each person.

20. The article of manufacture according to claim 19, wherein the allocating includes allocating said each person to one of the subdivisions based on a comparison of the profile score for said each person and the profile score for one or more of the subdivisions.
